(19) United States
(12) Patent Application Publication
(10) Pub. No.: US 2024/0334984 A1
(43) Pub. Date: Oct. 10, 2024

(54) AEROSOL-GENERATING DEVICE AND SYSTEM COMPRISING AN INDUCTIVE HEATING DEVICE AND METHOD OF OPERATING SAME

(71) Applicant: Philip Morris Products S.A., Neuchatel (CH)

(72) Inventors: Yannick BUTIN, Marin-Epagnier (CH); Maxime CHATEAU, Montlebon (FR); Enrico STURA, Palezieux-Village (CH)

(73) Assignee: Philip Morris Products S.A., Neuchatel (CH)

(21) Appl. No.: 18/577,895

(22) PCT Filed: Jul. 12, 2022
(86) PCT No.: PCT/EP2022/069459

§ 371 Date: Jan. 9, 2024

(30) Foreign Application Priority Data
Jul. 12, 2021 (EP) 21185114.2

(51) Int. Cl. A24F 40/57; A24F 40/20; A24F 40/465; A24F 40/53

(52) U.S. Cl. CPC A24F 40/57; A24F 40/465; A24F 40/20; A24F 40/53

(57) ABSTRACT

A method for controlling aerosol production in an aerosol-generating device is provided, the aerosol-generating device including an inductive heating arrangement configured to heat a susceptor, power supply electronics, and a power source configured to provide power to the power supply electronics, the method including: controlling the power provided to the power supply electronics to cause the susceptor to have a target temperature; measuring, using at least one temperature sensor, a temperature of the power supply electronics during operation of the aerosol-generating device for generating an aerosol; and adjusting the power provided to the power supply electronics based on a change of the measured temperature of the power supply electronics. An aerosol-generating device, and an aerosol-generating system including the aerosol-generating device and an aerosol-generating article, are also provided.

The present disclosure relates to an inductive heating device for heating an aerosol-forming substrate. The present invention further relates to an aerosol-generating device comprising such an inductive heating device and a method for controlling aerosol production in the aerosol-generating device.

Aerosol-generating devices may comprise an electrically-operated heat source that is configured to heat an aerosol-forming substrate to produce an aerosol. It is important for aerosol-generating devices to accurately monitor and control the temperature of the electrically operated heat source to ensure optimum generation and delivery of an aerosol to a user. In particular, it is important to ensure that the electrically-operated heat source does not overheat the aerosol-forming substrate as this may lead to the generation of undesirable compounds as well as an unpleasant taste and aroma for the user. To this end, aerosol-generating devices may comprise safety mechanisms in response to detection of overheating, such as generating an alarm and switching off the electrically-operated heat source.

It would be desirable to provide temperature monitoring and control of an inductive heating device that provides for reliable temperature regulation in order to reduce the risk of overheating and ensure continued normal operation of the aerosol-generating device.

According to an embodiment of the present invention, there is provided a method for controlling aerosol production in an aerosol-generating device. The aerosol-generating device comprises an inductive heating arrangement for heating a susceptor. The inductive heating arrangement comprises power supply electronics and a power source for providing power to the power supply electronics. The method comprises controlling the power provided to the power supply electronics to cause the susceptor to have a target temperature; measuring a temperature associated with the power supply electronics during operation of the aerosol-generating device for generating an aerosol; and adjusting the power provided to the power supply electronics based on a change of the measured temperature associated with the power supply electronics.

Adjusting the power provided to the power supply electronics based on a change of the measured temperature associated with the power supply electronics provides enables the temperature of the susceptor to be more accurately and reliably regulated, while reducing the need for recalibration during operation of the aerosol-generating device, which may affect the user experience.

Controlling the power provided to the power supply electronics to cause the susceptor to have a target temperature may comprise controlling the power provided to the power supply electronics to maintain a conductance value or a current value associated with the susceptor at a target value that corresponds to the target temperature.

Adjusting the power provided to the power supply electronics based at least in part on a change of the measured temperature associated with the power supply electronics may comprise controlling the power provided to the power supply electronics to decrease the conductance value or the current value associated with the susceptor as the measured temperature increases.

This prevents overheating for improved safety of the device when the aerosol-generating device is operating at or close to a maximum temperature. Further, overheating of the aerosol-forming substrate may result in the formation of undesired components of the aerosol-forming substrate. Thus, the more accurate and reliable regulation of the temperature of the susceptor improves safety for the user.

Decreasing the conductance value or the current value associated with the susceptor as the measured temperature increases may comprise decreasing the target conductance or current value by an amount based on a value of the change of the measured temperature such that the amount by which the target conductance or current value is decreased increases as the value of the change of the measured temperature increases.

The amount by which the target conductance or current value is decreased may be based on the amount of change of the measured temperature multiplied by a drift compensation value.

Controlling the power provided to the power supply electronics to cause the susceptor to have a target temperature may comprise controlling the power provided to the power supply electronics to maintain a resistance value associated with the susceptor at a target resistance value that corresponds to the target temperature.

Adjusting the power provided to the power supply electronics based at least in part on a change of the measured temperature associated with the power supply electronics may comprise controlling the power provided to the power supply electronics to increase the resistance value associated with the susceptor as the measured temperature increases.

This prevents overheating for improved safety of the device when the aerosol-generating device is operating at or close to a maximum temperature. Further, overheating of the aerosol-forming substrate may result in the formation of undesired components of the aerosol-forming substrate. Thus, the more accurate and reliable regulation of the temperature of the susceptor improves safety for the user.

Increasing the resistance value associated with the susceptor as the measured temperature increases may comprise increasing the target resistance value by an amount based on a value of the change of the measured temperature such that the amount by which the target resistance value is increased increases as the value of the change of the measured temperature increases.

The amount by which the target resistance value is decreased may be based on the amount of change of the measured temperature multiplied by a drift compensation value.

The drift compensation value may be a constant.

The drift compensation value may increase as the measured temperature associated with the power supply electronics increases.

This further reduces the risk of overheating the aerosol-forming substrate by further reducing the target conductance value or further increasing the target resistance value as the measured temperature increases.

The drift compensation value may increase according to a piecewise linear function, wherein the piecewise linear function comprises a first degree polynomial having a positive gradient and a first degree polynomial having a gradient of zero.

The drift compensation value may increase according to a square root function.

The method may further comprise storing at least one drift compensation value in a memory of the aerosol-generating device.

The method may further comprise storing a plurality of drift compensation values and respective corresponding temperature values in a memory of the aerosol-generating device.

The drift compensation value may be between 0.05 and 0.5.

The method may further comprise determining the drift compensation value. Determining the drift compensation value may comprise the steps of: i) controlling the power provided to the power supply electronics to cause the susceptor to have a first known temperature; when the susceptor is at the first known temperature: ii) determining a conductance value, a current value or a resistance value associated with the susceptor; iii) determining a temperature associated with the power supply electronics; and repeating steps i) to iii) at least twice.

The target conductance value, target current value, or target resistance value may be determined based on a first calibration value corresponding to a first known temperature of the susceptor and a second calibration value corresponding to a second known temperature of the susceptor. The second known temperature of the susceptor may be greater than the first known temperature of the susceptor.

The target conductance value, target current value, or target resistance value may be defined according to a heating profile as a predetermined percentage of a difference between the first calibration value and the second calibration value.

The heating profile may define a stepwise increase of temperature from a first operating temperature to a second operating temperature.

The first operating temperature may be sufficient for the aerosol-forming substrate to form an aerosol.

The second operating temperature may be below the second known temperature.

The heating profile may define at least three consecutive temperature steps, each temperature step having a respective duration.

Controlling the power provided to the inductive heating arrangement to cause the step-wise increase of a temperature of the susceptor enables generation of an aerosol over a sustained period encompassing the full user experience of a number of puffs, for example 14 puffs, or a predetermined time interval, such as 6 minutes, where the deliveries (nicotine, flavors, aerosol volume and so on) are substantially constant for each puff throughout the user experience. Specifically, the stepwise increase if the temperature of the susceptor prevents the reduction of aerosol delivery due to substrate depletion in the vicinity of the susceptor and reduced thermodiffusion over time. Furthermore, the step-wise increase in temperature allows for the heat to spread within the substrate at each step.

The method may further comprise calibrating the aerosol-generating device to measure the first calibration value and the second calibration value. Calibrating the aerosol-generating device may comprise: controlling the power provided to the inductive heating arrangement to cause heating and cooling of the susceptor through a predetermined temperature range; and monitoring a power source parameter to identify a start point and an end point of a reversible phase transition of the susceptor, wherein the power source parameter is one of a current, a conductance or a resistance. The first calibration value may be a power source parameter value corresponding to the start point of the reversible phase transition of the susceptor. The second calibration value may be a power source parameter value corresponding to the end point of the reversible phase transition of the susceptor.

The calibrating the aerosol-generating device to measure the first calibration value and the second calibration value before operation of the heating arrangement for generating an aerosol.

The method may further comprise calibrating the aerosol-generating device to measure the first calibration value and the second calibration value during operation of the heating arrangement for generating an aerosol.

Accordingly, the calibration values used to control the heating process are more accurate and reliable than if the calibration process were performed at manufacturing. This is especially important if the susceptor forms part of a separate aerosol-generating article that does not form part of the aerosol generating device. In such circumstances calibration at manufacturing is not possible.

Measuring a temperature associated with the power supply electronics during operation of the aerosol-generating device for generating an aerosol may comprise measuring the temperature of a first portion of the power supply electronics using a first temperature sensor.

The first temperature sensor may be one of a thermocouple, a negative temperature coefficient resistive temperature sensor, and a positive temperature coefficient resistive temperature sensor.

Measuring a temperature of at least one portion of the power supply electronics during operation of the aerosol-generating device further comprises measuring the temperature of a second portion of the power supply electronics using a second temperature sensor.

The second temperature sensor may be one of a thermocouple, a negative temperature coefficient resistive temperature sensor, and a positive temperature coefficient resistive temperature sensor.

The method may further comprise measuring a DC current drawn the power source, wherein the conductance value or the resistance value is determined based on a DC supply voltage of the power source and the DC current drawn from the power source.

The method may further comprise measuring the DC supply voltage of the power source.

According to another embodiment of the present invention, there is provided an aerosol-generating device. The aerosol-generating device comprises an inductive heating arrangement for heating a susceptor and a controller. The inductive heating arrangement comprises power supply electronics and a power source for providing power to the power supply electronics. The controller comprises at least one temperature sensor arranged to measure a temperature associated with the power supply electronics during operation of the aerosol-generating device for generating an aerosol. The controller is configured to: control the power provided to the power supply electronics to cause the susceptor to have a target temperature; and adjust the power provided to the power supply electronics based on a change of the measured temperature associated with the power supply electronics.

Controlling the power provided to the power supply electronics to cause the susceptor to have a target temperature may comprise controlling the power provided to the power supply electronics to maintain a conductance value or a current value associated with the susceptor at a target value that corresponds to the target temperature.

Adjusting the power provided to the power supply electronics based at least in part on a change of the measured temperature associated with the power supply electronics may comprise controlling the power provided to the power supply electronics to decrease the conductance value or the current value associated with the susceptor as the measured temperature increases.

The controller may be configured to decrease the conductance value or the current value associated with the susceptor as the measured temperature increases by decreasing the target conductance or current value by an amount based on a value of the change of the measured temperature such that the amount by which the target conductance or current value is decreased increases as the value of the change of the measured temperature increases.

The amount by which the target conductance or current value is decreased may be based on the amount of change of the measured temperature multiplied by a drift compensation value.

Controlling the power provided to the power supply electronics to cause the susceptor to have a target temperature may comprise controlling the power provided to the power supply electronics to maintain a resistance value associated with the susceptor at a target value that corresponds to the target temperature.

Adjusting the power provided to the power supply electronics based at least in part on a change of the measured temperature associated with the power supply electronics may comprise controlling the power provided to the power supply electronics to increase the resistance value associated with the susceptor as the measured temperature increases.

Increasing the resistance value associated with the susceptor as the measured temperature increases may comprise increasing the target resistance value by an amount based on a value of the change of the measured temperature such that the amount by which the target resistance value is increased increases as the value of the change of the measured temperature increases.

The amount by which the target resistance value is decreased may be based on the amount of change of the measured temperature multiplied by a drift compensation value.

The drift compensation value may be a constant.

The drift compensation value may increase as the measured temperature associated with the power supply electronics increases.

The drift compensation value may increase according to a piecewise linear function, wherein the piecewise linear function comprises a first degree polynomial having a positive gradient and a first degree polynomial having a gradient of zero.

The drift compensation value may increase according to a square root function.

The aerosol-generating device may further comprise a memory configured to store at least one drift compensation value.

The aerosol-generating device may further comprise a memory configured to store a plurality of drift compensation values and respective corresponding temperature values.

The drift compensation value may be between 0.05 and 0.5.

The controller may configured to determine the drift compensation value by performing steps comprising: i) controlling the power provided to the power supply electronics to cause the susceptor to have a first known temperature; when the susceptor is at the first known temperature: ii) determining a conductance value, a current value or a resistance value associated with the susceptor; iii) determining a temperature of associated with the power supply electronics; and repeating steps i) to iii) at least twice.

The target conductance value, current value or resistance value may be determined based on a first calibration value corresponding to a first known temperature of the susceptor and a second calibration value corresponding to a second known temperature of the susceptor. The second known temperature of the susceptor may be greater than the first known temperature of the susceptor.

The target conductance value, current value or resistance value may be defined according to a heating profile as a predetermined percentage of a difference between the first calibration value and the second calibration value.

The heating profile may define a stepwise increase of temperature from a first operating temperature to a second operating temperature.

The first operating temperature may be sufficient for the aerosol-forming substrate to form an aerosol.

The second operating temperature may be below the second known temperature.

The heating profile may define at least three consecutive temperature steps, each temperature step having a respective duration.

The aerosol-generating device, wherein the controller may be further configured to calibrate the aerosol-generating device to measure the first calibration value and the second calibration value. Calibrating the aerosol-generating device may comprise: controlling the power provided to the inductive heating arrangement to cause heating and cooling of the susceptor through a predetermined temperature range; and monitoring a power source parameter to identify a start point and an end point of a reversible phase transition of the susceptor. The power source parameter may be one of a current, a conductance or a resistance. The first calibration value may be a power source parameter value corresponding to the start point of the reversible phase transition of the susceptor. The second calibration value may be a power source parameter value corresponding to the end point of the reversible phase transition of the susceptor.

The controller may be further configured to perform a calibration of the aerosol-generating device to measure the first calibration value and the second calibration value before operation of the heating arrangement for generating an aerosol.

The controller may be further configured to calibrate the aerosol-generating device to measure the first calibration value and the second calibration value during operation of the heating arrangement for generating an aerosol.

The at least one temperature sensor may be one of a thermocouple, a negative temperature coefficient resistive temperature sensor, and a positive temperature coefficient resistive temperature sensor.

The at least one temperature sensor may comprise a first temperature sensor and a second temperature sensor.

The first temperature sensor may be one of a thermocouple, a negative temperature coefficient resistive temperature sensor, and a positive temperature coefficient resistive temperature sensor and the second temperature sensor may be one of a thermocouple, a negative temperature coefficient resistive temperature sensor, and a positive temperature coefficient resistive temperature sensor.

The aerosol-generating device may further comprise a current sensor configured to measure a DC current drawn from the power source, wherein the conductance value or the resistance value is determined based on a DC supply voltage of the power source and the DC current drawn from the power source.

The aerosol-generating device may further comprise a voltage sensor configured to measure the DC supply voltage of the power source.

According to another embodiment of the present invention, there is provided an aerosol-generating system comprising: the aerosol-generating device described above and an aerosol-generating article. The aerosol-generating article may comprise an aerosol-forming substrate and the susceptor in thermal contact with the aerosol-forming substrate.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomizer, such as an electric heater, to heat the aerosol-forming substrate to form an aerosol.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

As used herein, the term “aerosol-forming substrate” refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. An aerosol-generating article may be disposable. An aerosol-generating article comprising an aerosol-forming substrate comprising tobacco may be referred to herein as a tobacco stick.

An aerosol-forming substrate may comprise nicotine. An aerosol-forming substrate may comprise tobacco, for example may comprise a tobacco-containing material containing volatile tobacco flavor compounds, which are released from the aerosol-forming substrate upon heating. In preferred embodiments an aerosol-forming substrate may comprise homogenized tobacco material, for example cast leaf tobacco. The aerosol-forming substrate may comprise both solid and liquid components. The aerosol-forming substrate may comprise a tobacco-containing material containing volatile tobacco flavor compounds, which are released from the substrate upon heating. The aerosol-forming substrate may comprise a non-tobacco material. The aerosol-forming substrate may further comprise an aerosol former. Examples of suitable aerosol formers are glycerin and propylene glycol.

As used herein, “aerosol-cooling element” refers to a component of an aerosol-generating article located downstream of the aerosol-forming substrate such that, in use, an aerosol formed by volatile compounds released from the aerosol-forming substrate passes through and is cooled by the aerosol cooling element before being inhaled by a user. An aerosol cooling element has a large surface area, but causes a low pressure drop. Filters and other mouthpieces that produce a high pressure drop, for example filters formed from bundles of fibers, are not considered to be aerosol-cooling elements. Chambers and cavities within an aerosol-generating article are not considered to be aerosol cooling elements.

As used herein, the term “mouthpiece” refers to a portion of an aerosol-generating article, an aerosol-generating device or an aerosol-generating system that is placed into a user's mouth in order to directly inhale an aerosol.

As used herein, the term “susceptor” refers to an element comprising a material that is capable of converting the energy of a magnetic field into heat. When a susceptor is located in an alternating magnetic field, the susceptor is heated. Heating of the susceptor may be the result of at least one of hysteresis losses and eddy currents induced in the susceptor, depending on the electrical and magnetic properties of the susceptor material.

As used herein when referring to an aerosol-generating device, the terms “upstream” and “front”, and “downstream” and “rear”, are used to describe the relative positions of components, or portions of components, of the aerosol-generating device in relation to the direction in which air flows through the aerosol-generating device during use thereof. Aerosol-generating devices according to the invention comprise a proximal end through which, in use, an aerosol exits the device. The proximal end of the aerosol-generating device may also be referred to as the mouth end or the downstream end. The mouth end is downstream of the distal end. The distal end of the aerosol-generating article may also be referred to as the upstream end. Components, or portions of components, of the aerosol-generating device may be described as being upstream or downstream of one another based on their relative positions with respect to the airflow path of the aerosol-generating device.

As used herein when referring to an aerosol-generating article, the terms “upstream” and “front”, and “downstream” and “rear”, are used to describe the relative positions of components, or portions of components, of the aerosol-generating article in relation to the direction in which air flows through the aerosol-generating article during use thereof. Aerosol-generating articles according to the invention comprise a proximal end through which, in use, an aerosol exits the article. The proximal end of the aerosol-generating article may also be referred to as the mouth end or the downstream end. The mouth end is downstream of the distal end. The distal end of the aerosol-generating article may also be referred to as the upstream end. Components, or portions of components, of the aerosol-generating article may be described as being upstream or downstream of one another based on their relative positions between the proximal end of the aerosol-generating article and the distal end of the aerosol-generating article. The front of a component, or portion of a component, of the aerosol-generating article is the portion at the end closest to the upstream end of the aerosol-generating article. The rear of a component, or portion of a component, of the aerosol-generating article is the portion at the end closest to the downstream end of the aerosol-generating article.

As used herein, the term “inductively couple” refers to the heating of a susceptor when penetrated by an alternating magnetic field. The heating may be caused by the generation of eddy currents in the susceptor. The heating may be caused by magnetic hysteresis losses.

As used herein, the term “puff” means the action of a user drawing an aerosol into their body through their mouth or nose.

As used herein, the term “temperature sensor” refers to a thermocouple, a negative temperature coefficient resistive temperature sensor or a positive temperature coefficient resistive temperature sensor.

The invention is defined in the claims. However, below there is provided a non-exhaustive list of non-limiting examples. Any one or more of the features of these examples may be combined with any one or more features of another example, embodiment, or aspect described herein.

Example Ex1: A method for controlling aerosol production in an aerosol-generating device, the aerosol-generating device comprising an inductive heating arrangement for heating a susceptor, the inductive heating arrangement comprising power supply electronics and a power source for providing power to the power supply electronics, the method comprising: controlling the power provided to the power supply electronics to cause the susceptor to have a target temperature; measuring a temperature associated with the power supply electronics during operation of the aerosol-generating device for generating an aerosol; and adjusting the power provided to the power supply electronics based on a change of the measured temperature associated with the power supply electronics.

Example Ex2: The method according to example Ex1, wherein controlling the power provided to the power supply electronics to cause the susceptor to have a target temperature comprises controlling the power provided to the power supply electronics to maintain a conductance value or a current value associated with the susceptor at a target value that corresponds to the target temperature.

Example Ex3: The method according to example Ex2, wherein adjusting the power provided to the power supply electronics based at least in part on a change of the measured temperature associated with the power supply electronics comprises controlling the power provided to the power supply electronics to decrease the conductance value or the current value associated with the susceptor as the measured temperature increases.

Example Ex4: The method according to example Ex3, wherein decreasing the conductance value or the current value associated with the susceptor as the measured temperature increases comprises decreasing the target conductance or current value by an amount based on a value of the change of the measured temperature such that the amount by which the target conductance or current value is decreased increases as the value of the change of the measured temperature increases.

Example Ex5: The method according example Ex4, wherein the amount by which the target conductance or current value is decreased is based on the amount of change of the measured temperature multiplied by a drift compensation value.

Example Ex6: The method according to example Ex1, wherein controlling the power provided to the power supply electronics to cause the susceptor to have a target temperature comprises controlling the power provided to the power supply electronics to maintain a resistance value associated with the susceptor at a target resistance value that corresponds to the target temperature.

Example Ex7: The method according to example Ex6, wherein adjusting the power provided to the power supply electronics based at least in part on a change of the measured temperature associated with the power supply electronics comprises controlling the power provided to the power supply electronics to increase the resistance value associated with the susceptor as the measured temperature increases.

Example Ex8: The method according to example Ex7, wherein increasing the resistance value associated with the susceptor as the measured temperature increases comprises increasing the target resistance value by an amount based on a value of the change of the measured temperature such that the amount by which the target resistance value is increased increases as the value of the change of the measured temperature increases.

Example Ex9: The method according to example Ex8, wherein the amount by which the target resistance value is decreased is based on the amount of change of the measured temperature multiplied by a drift compensation value.

Example Ex10: The method according to example Ex5 or Ex9, wherein the drift compensation value is a constant.

Example Ex11: The method according to example Ex5 or Ex9, wherein the drift compensation value increases as the measured temperature associated with the power supply electronics increases.

Example Ex12: The method according to example Ex11, wherein the drift compensation value increases according to a piecewise linear function, wherein the piecewise linear function comprises a first degree polynomial having a positive gradient and a first degree polynomial having a gradient of zero.

Example Ex13: The method according to example Ex11, wherein the drift compensation value increases according to a square root function.

Example Ex14: The method according to example Ex5 or examples Ex9 to Ex13, further comprising storing at least one drift compensation value in a memory of the aerosol-generating device.

Example Ex15: The method according to example Ex5 or examples Ex9 to Ex13, further comprising storing a plurality of drift compensation values and respective corresponding temperature values in a memory of the aerosol-generating device.

Example Ex16: The method according to example Ex5 or examples Ex9 to Ex15, wherein the drift compensation value is between 0.05 and 0.5.

Example Ex17: The method according to example Ex5 or examples Ex9 to Ex16, further comprising determining the drift compensation value, comprising the steps of: i) controlling the power provided to the power supply electronics to cause the susceptor to have a first known temperature; when the susceptor is at the first known temperature: ii) determining a conductance value, a current value or a resistance value associated with the susceptor; iii) determining a temperature associated with the power supply electronics; and repeating steps i) to iii) at least twice.

Example Ex18: The method according to any of examples Ex2 to Ex17, wherein the target conductance value, target current value, or target resistance value is determined based on a first calibration value corresponding to a first known temperature of the susceptor and a second calibration value corresponding to a second known temperature of the susceptor, wherein the second known temperature of the susceptor is greater than the first known temperature of the susceptor.

Example Ex19: The method according to example Ex18, wherein the target conductance value, target current value, or target resistance value is defined according to a heating profile as a predetermined percentage of a difference between the first calibration value and the second calibration value.

Example Ex20: The method according to example Ex19, wherein the heating profile defines a stepwise increase of temperature from a first operating temperature to a second operating temperature.

Example Ex21: The method according to example Ex20, wherein the first operating temperature is sufficient for the aerosol-forming substrate to form an aerosol.

Example Ex22: The method according to example Ex19 or Ex21, wherein the second operating temperature is below the second known temperature.

Example Ex23: The method according any of examples Ex19 to Ex22, wherein the heating profile defines at least three consecutive temperature steps, each temperature step having a respective duration.

Example Ex24: The method according to any of examples Ex18 to Ex23, further comprising calibrating the aerosol-generating device to measure the first calibration value and the second calibration value, wherein calibrating the aerosol-generating device comprises: controlling the power provided to the inductive heating arrangement to cause heating and cooling of the susceptor through a predetermined temperature range; and monitoring a power source parameter to identify a start point and an end point of a reversible phase transition of the susceptor, wherein the power source parameter is one of a current, a conductance or a resistance, wherein the first calibration value is a power source parameter value corresponding to the start point of the reversible phase transition of the susceptor, and wherein the second calibration value is a power source parameter value corresponding to the end point of the reversible phase transition of the susceptor.

Example Ex25: The method according to any of examples Ex18 to Ex24, further comprising calibrating the aerosol-generating device to measure the first calibration value and the second calibration value before operation of the heating arrangement for generating an aerosol.

Example Ex26: The method according to any of examples Ex18 to Ex24, further comprising calibrating the aerosol-generating device to measure the first calibration value and the second calibration value during operation of the heating arrangement for generating an aerosol.

Example Ex27: The method according to any of examples Ex1 to Ex26, wherein measuring a temperature associated with the power supply electronics during operation of the aerosol-generating device for generating an aerosol comprises measuring the temperature of a first portion of the power supply electronics using a first temperature sensor.

Example Ex28: The method according to example Ex27, wherein the first temperature sensor is one of a thermocouple, a negative temperature coefficient resistive temperature sensor, and a positive temperature coefficient resistive temperature sensor.

Example Ex29: The method according to any of examples Ex1 to Ex28, wherein measuring a temperature of at least one portion of the power supply electronics during operation of the aerosol-generating device further comprises measuring the temperature of a second portion of the power supply electronics using a second temperature sensor.

Example Ex30: The method according to example Ex29, wherein the second temperature sensor is one of a thermocouple, a negative temperature coefficient resistive temperature sensor, and a positive temperature coefficient resistive temperature sensor.

Example Ex31: The method according to any of examples Ex2 to Ex30, further comprising measuring a DC current drawn the power source, wherein the conductance value or the resistance value is determined based on a DC supply voltage of the power source and the DC current drawn from the power source.

Examples Ex32: The method according to example Ex31, further comprising measuring the DC supply voltage of the power source.

Example Ex33: An aerosol-generating device comprising: an inductive heating arrangement for heating a susceptor, the inductive heating arrangement comprising power supply electronics and a power source for providing power to the power supply electronics; and a controller comprising at least one temperature sensor arranged to measure a temperature associated with the power supply electronics during operation of the aerosol-generating device for generating an aerosol, wherein the controller is configured to: control the power provided to the power supply electronics to cause the susceptor to have a target temperature; and adjust the power provided to the power supply electronics based on a change of the measured temperature associated with the power supply electronics.

Example Ex34: The aerosol-generating device according to example Ex33, wherein controlling the power provided to the power supply electronics to cause the susceptor to have a target temperature comprises controlling the power provided to the power supply electronics to maintain a conductance value or a current value associated with the susceptor at a target value that corresponds to the target temperature.

Example Ex35: The aerosol-generating device according to example Ex34, wherein adjusting the power provided to the power supply electronics based at least in part on a change of the measured temperature associated with the power supply electronics comprises controlling the power provided to the power supply electronics to decrease the conductance value or the current value associated with the susceptor as the measured temperature increases.

Example Ex36: The aerosol-generating device according to example Ex35, wherein the controller is configured to decrease the conductance value or the current value associated with the susceptor as the measured temperature increases by decreasing the target conductance or current value by an amount based on a value of the change of the measured temperature such that the amount by which the target conductance or current value is decreased increases as the value of the change of the measured temperature increases.

Example Ex37: The aerosol-generating device according example Ex36, wherein the amount by which the target conductance or current value is decreased is based on the amount of change of the measured temperature multiplied by a drift compensation value.

Example Ex38: The aerosol-generating device according to example Ex33, wherein controlling the power provided to the power supply electronics to cause the susceptor to have a target temperature comprises controlling the power provided to the power supply electronics to maintain a resistance value associated with the susceptor at a target value that corresponds to the target temperature.

Example Ex39: The aerosol-generating device according to example Ex38, wherein adjusting the power provided to the power supply electronics based at least in part on a change of the measured temperature associated with the power supply electronics comprises controlling the power provided to the power supply electronics to increase the resistance value associated with the susceptor as the measured temperature increases.

Example Ex40: The aerosol-generating device according to example Ex39, wherein increasing the resistance value associated with the susceptor as the measured temperature increases comprises increasing the target resistance value by an amount based on a value of the change of the measured temperature such that the amount by which the target resistance value is increased increases as the value of the change of the measured temperature increases.

Example Ex41: The aerosol-generating device according to example Ex40, wherein the amount by which the target resistance value is decreased is based on the amount of change of the measured temperature multiplied by a drift compensation value.

Example Ex42: The aerosol-generating device according to example Ex37 or Ex41, wherein the drift compensation value is a constant.

Example Ex43: The aerosol-generating device according to example Ex37 or Ex41, wherein the drift compensation value increases as the measured temperature associated with the power supply electronics increases.

Example Ex44: The aerosol-generating device according to example Ex43, wherein the drift compensation value increases according to a piecewise linear function, wherein the piecewise linear function comprises a first degree polynomial having a positive gradient and a first degree polynomial having a gradient of zero.

Example Ex45: The aerosol-generating device according to example Ex44, wherein the drift compensation value increases according to a square root function.

Example Ex46: The aerosol-generating device according to example Ex37 or examples Ex41 to Ex45, further comprising a memory configured to store at least one drift compensation value.

Example Ex47: The aerosol-generating device according to example Ex37 or examples Ex41 to Ex45, further comprising a memory configured to store a plurality of drift compensation values and respective corresponding temperature values.

Example Ex48: The aerosol-generating device according to example Ex37 or examples Ex41 to Ex47, wherein the drift compensation value is between 0.05 and 0.5.

Example Ex49: The aerosol-generating device according to example Ex37 or examples Ex41 to Ex48, wherein the controller is configured to determine the drift compensation value by performing steps comprising: i) controlling the power provided to the power supply electronics to cause the susceptor to have a first known temperature; when the susceptor is at the first known temperature: ii) determining a conductance value, a current value or a resistance value associated with the susceptor; iii) determining a temperature of associated with the power supply electronics; and repeating steps i) to iii) at least twice.

Example Ex50: The aerosol-generating device according to any of examples Ex34 to Ex49, wherein the target conductance value, current value or resistance value is determined based on a first calibration value corresponding to a first known temperature of the susceptor and a second calibration value corresponding to a second known temperature of the susceptor, wherein the second known temperature of the susceptor is greater than the first known temperature of the susceptor.

Example Ex51: The aerosol-generating device according to example Ex50, wherein the target conductance value, current value or resistance value is defined according to a heating profile as a predetermined percentage of a difference between the first calibration value and the second calibration value.

Example Ex52: The aerosol-generating device according to example Ex51, wherein the heating profile defines a stepwise increase of temperature from a first operating temperature to a second operating temperature.

Example Ex53: The aerosol-generating device according to example Ex52, wherein the first operating temperature is sufficient for the aerosol-forming substrate to form an aerosol.

Example Ex54: The aerosol-generating device according to example Ex52 or Ex53, wherein the second operating temperature is below the second known temperature.

Example Ex55: The aerosol-generating device according any of examples Ex51 to Ex54, wherein the heating profile defines at least three consecutive temperature steps, each temperature step having a respective duration.

Example Ex56: The aerosol-generating device according to any of examples Ex52 to Ex55, wherein the controller is further configured to calibrate the aerosol-generating device to measure the first calibration value and the second calibration value, wherein calibrating the aerosol-generating device comprises: controlling the power provided to the inductive heating arrangement to cause heating and cooling of the susceptor through a predetermined temperature range; and monitoring a power source parameter to identify a start point and an end point of a reversible phase transition of the susceptor, wherein the power source parameter is one of a current, a conductance or a resistance, wherein the first calibration value is a power source parameter value corresponding to the start point of the reversible phase transition of the susceptor, and wherein the second calibration value is a power source parameter value corresponding to the end point of the reversible phase transition of the susceptor.

Example Ex57: The aerosol-generating device according to any of examples Ex51 to Ex56, wherein the controller is further configured to perform a calibration of the aerosol-generating device to measure the first calibration value and the second calibration value before operation of the heating arrangement for generating an aerosol.

Example Ex58: The aerosol-generating device according to any of examples Ex51 to Ex57, wherein the controller is further configured to calibrate the aerosol-generating device to measure the first calibration value and the second calibration value during operation of the heating arrangement for generating an aerosol.

Example Ex59: The aerosol-generating device according to any of examples Ex33 to Ex58, wherein the at least one temperature sensor is one of a thermocouple, a negative temperature coefficient resistive temperature sensor, and a positive temperature coefficient resistive temperature sensor.

Example Ex60: The aerosol-generating device according to any of examples Ex33 to Ex58, wherein the at least one temperature sensor comprises a first temperature sensor and a second temperature sensor.

Example Ex61: The aerosol-generating device according to examples Ex60, wherein the first temperature sensor is one of a thermocouple, a negative temperature coefficient resistive temperature sensor, and a positive temperature coefficient resistive temperature sensor and the second temperature sensor is one of a thermocouple, a negative temperature coefficient resistive temperature sensor, and a positive temperature coefficient resistive temperature sensor.

Example Ex62: The aerosol-generating device according to any of examples Ex34 to Ex61, further comprising a current sensor configured to measure a DC current drawn from the power source, wherein the conductance value or the resistance value is determined based on a DC supply voltage of the power source and the DC current drawn from the power source

Example Ex63: The aerosol-generating device according to example Ex62, further comprising a voltage sensor configured to measure the DC supply voltage of the power source.

Example Ex64: An aerosol-generating system comprising: the aerosol-generating device according to any of examples Ex34 to Ex63; and an aerosol-generating article, wherein the aerosol-generating article comprises an aerosol-forming substrate and the susceptor in thermal contact with the aerosol-forming substrate.

Examples will now be further described with reference to the figures in which:

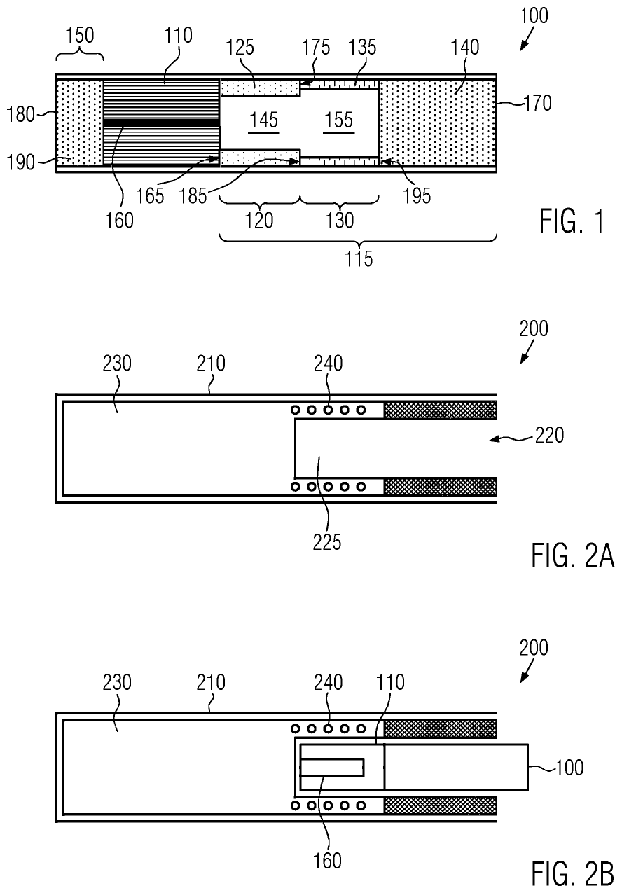

FIG. 1 shows a schematic cross-sectional illustration of an aerosol-generating article;

FIG. 2A shows a schematic cross-sectional illustration of an aerosol-generating device for use with the aerosol-generating article illustrated in FIG. 1;

FIG. 2B shows a schematic cross-sectional illustration of the aerosol-generating device in engagement with the aerosol-generating article illustrated in FIG. 1;

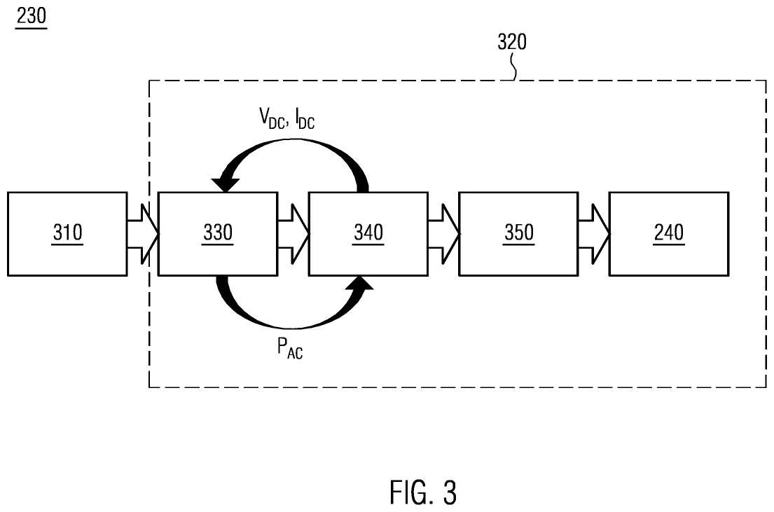

FIG. 3 is a block diagram showing an inductive heating device of the aerosol-generating device described in relation to FIG. 2;

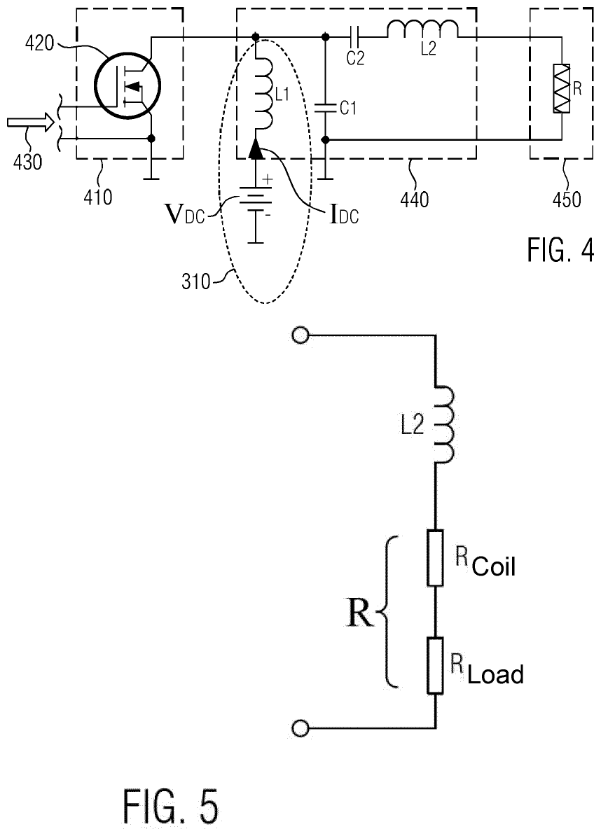

FIG. 4 is a schematic diagram showing electronic components of the inductive heating device described in relation to FIG. 3;

FIG. 5 is a schematic diagram on an inductor of an LC load network of the inductive heating device described in relation to FIG. 4;

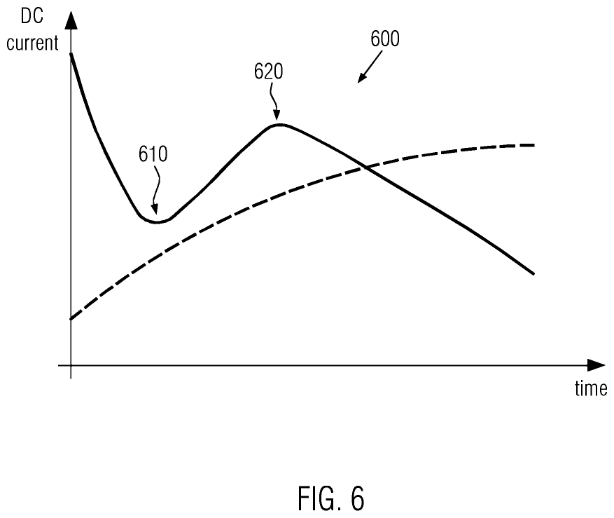

FIG. 6 is a graph of DC current vs. time illustrating the remotely detectable current changes that occur when a susceptor material undergoes a phase transition associated with its Curie point;

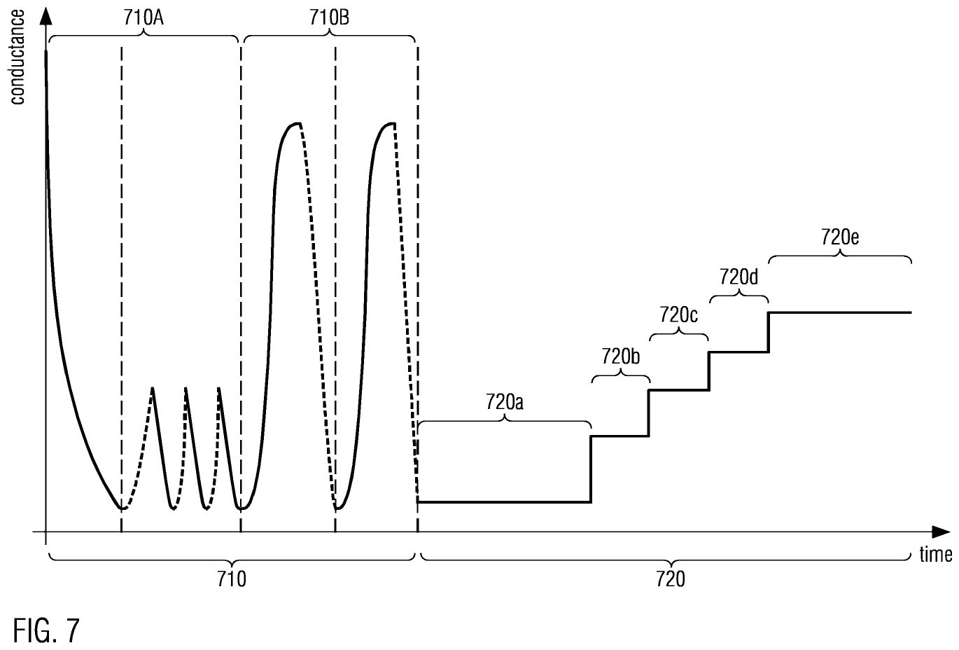

FIG. 7 illustrates a temperature profile of the susceptor during operation of the aerosol-generating device;

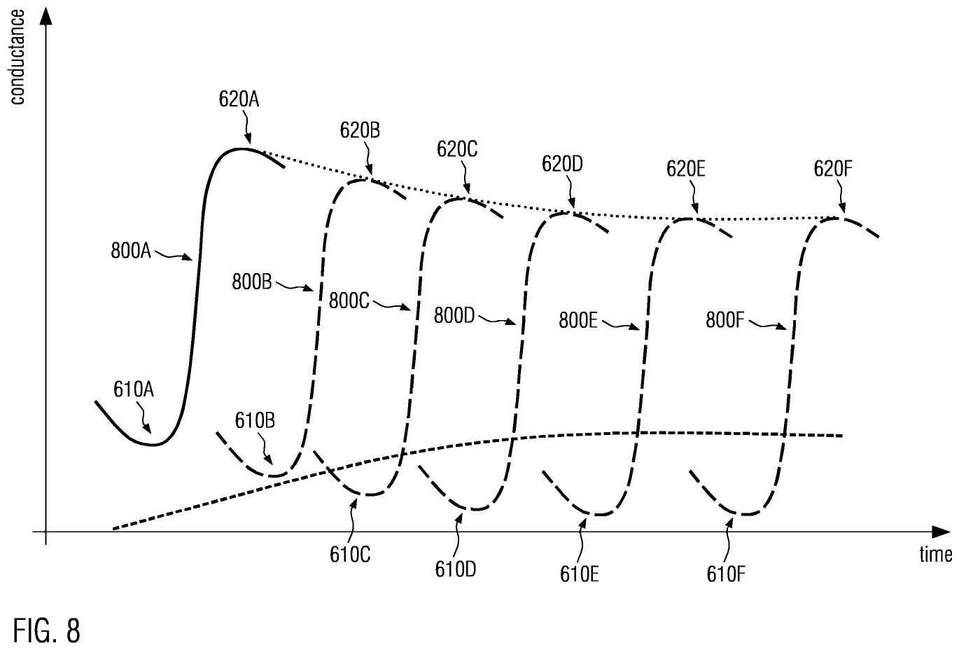

FIG. 8 is a graph of conductance vs. time illustrating the drift in the calibration curve with increasing temperature of the power supply electronics;

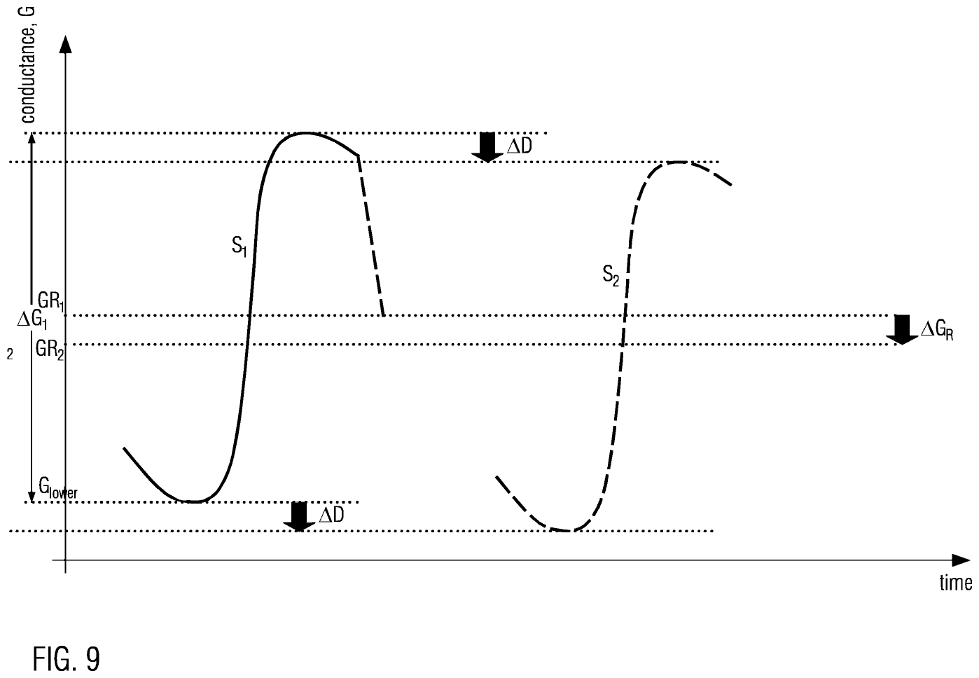

FIG. 9 is a graph of conductance vs. time illustrating in more detail the drift in the calibration curve with increasing temperature of the power supply electronics;

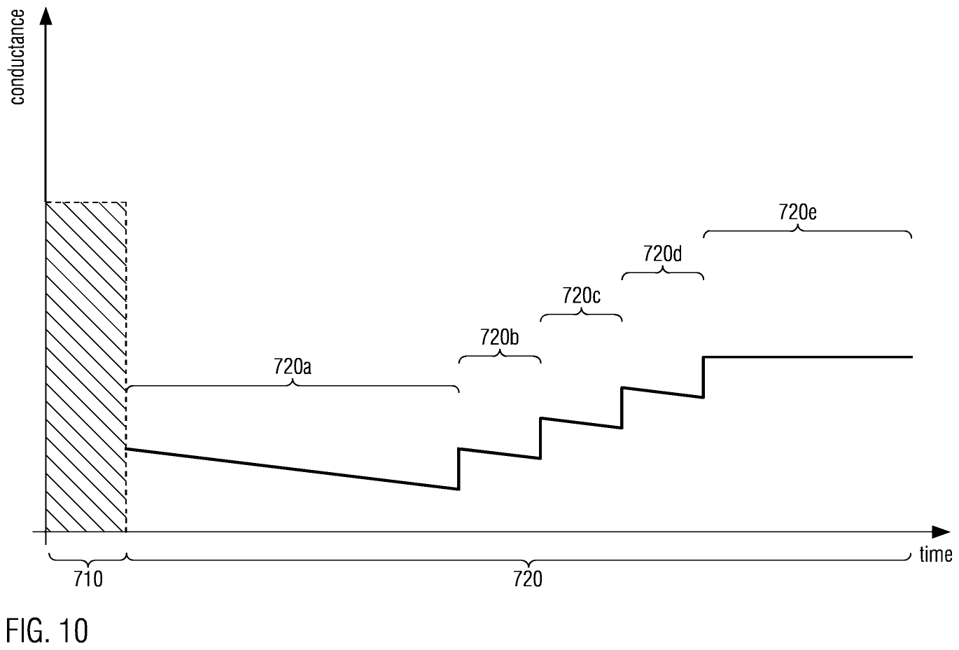

FIG. 10 illustrates a temperature profile of the susceptor during operation of the aerosol-generating device with drift compensation;

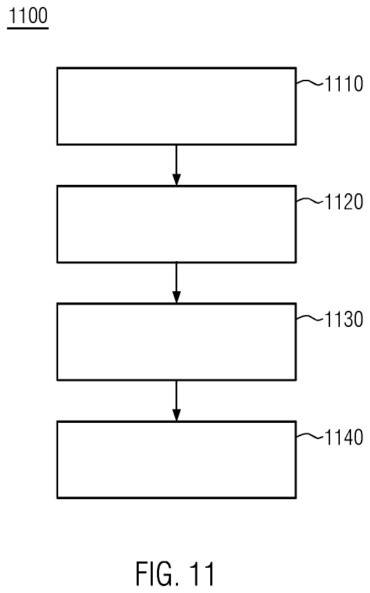

FIG. 11 is a flow diagram showing a method for controlling aerosol-production in the aerosol-generating device of FIG. 2.

FIG. 1 illustrates a schematic side sectional view of an aerosol-generating article 100. The aerosol-generating article 100 comprises a rod of aerosol-forming substrate 110 and a downstream section 115 at a location downstream of the rod of aerosol-forming substrate 110. The aerosol-generating article 100 comprises an upstream section 150 at a location upstream of the rod of aerosol-forming substrate. Thus, the aerosol-generating article 100 extends from an upstream or distal end 180 to a downstream or mouth end 170. In use, air is drawn through the aerosol-generating article 100 by a user from the distal end 180 to the mouth end 170.

The downstream section 115 comprises a support element 120 located immediately downstream of the rod of aerosol-forming substrate, the support element 120 being in longitudinal alignment with the rod 110. The upstream end of the support element 120 abuts the downstream end of the rod of aerosol-forming substrate 110. In addition, the downstream section 115 comprises an aerosol-cooling element 130 located immediately downstream of the support element 120, the aerosol-cooling element 130 being in longitudinal alignment with the rod 110 and the support element 120. The upstream end of the aerosol-cooling element 130 abuts the downstream end of the support element 120. In use, volatile substances released from the aerosol-forming substrate 110 pass along the aerosol-cooling element 130 towards the mouth end 170 of the aerosol-generating article 100. The volatile substances may cool within the aerosol-cooling element 130 to form an aerosol that is inhaled by the user.

The support element 120 comprises a first hollow tubular segment 125. The first hollow tubular segment 125 is provided in the form of a hollow cylindrical tube made of cellulose acetate. The first hollow tubular segment 125 defines an internal cavity 145 that extends all the way from an upstream end 165 of the first hollow tubular segment 125 to a downstream end 175 of the first hollow tubular segment 125.

The aerosol-cooling element 130 comprises a second hollow tubular segment 135. The second hollow tubular segment 135 is provided in the form of a hollow cylindrical tube made of cellulose acetate. The second hollow tubular segment 135 defines an internal cavity 155 that extends all the way from an upstream end 185 of the second hollow tubular segment 135 to a downstream end 195 of the second hollow tubular segment 135. In addition, a ventilation zone (not shown) is provided at a location along the second hollow tubular segment 135. A ventilation level of the aerosol-generating article 10 is about 25 percent.

The downstream section 115 further comprises a mouthpiece 140 positioned immediately downstream of the aerosol-cooling element 130. As shown in the drawing of FIG. 1, an upstream end of the mouthpiece 140 abuts the downstream end 195 of the aerosol-cooling element 130. The mouthpiece 140 is provided in the form of a cylindrical plug of low-density cellulose acetate.

The aerosol-generating article 100 further comprises an elongate susceptor 160 within the rod of aerosol-generating substrate 110. In more detail, the susceptor 160 is arranged substantially longitudinally within the aerosol-forming substrate 110, such as to be approximately parallel to the longitudinal direction of the rod 110. As shown in the drawing of FIG. 1, the susceptor 160 is positioned in a radially central position within the rod and extends effectively along the longitudinal axis of the rod 110.

The susceptor 160 extends all the way from an upstream end to a downstream end of the rod of aerosol-forming substrate 110. In effect, the susceptor 160 has substantially the same length as the rod of aerosol-forming substrate 110. The susceptor 160 is located in thermal contact with the aerosol-forming substrate 110, such that the aerosol-forming substrate 110 is heated by the susceptor 160 when the susceptor 160 is heated.

The upstream section 150 comprises an upstream element 190 located immediately upstream of the rod of aerosol-forming substrate 110, the upstream element 190 being in longitudinal alignment with the rod 110. The downstream end of the upstream element 190 abuts the upstream end of the rod of aerosol-forming substrate. This advantageously prevents the susceptor 160 from being dislodged. Further, this ensures that the consumer cannot accidentally contact the heated susceptor 160 after use. The upstream element 190 is provided in the form of a cylindrical plug of cellulose acetate circumscribed by a stiff wrapper.

The susceptor 160 comprises at least two different materials. The susceptor 160 comprises at least two layers: a first layer of a first susceptor material disposed in physical contact with a second layer of a second susceptor material. The first susceptor material and the second susceptor material may each have a Curie temperature. In this case, the Curie temperature of the second susceptor material is lower than the Curie temperature of the first susceptor material. The first material may not have a Curie temperature. The first susceptor material may be aluminum, iron or stainless steel. The second susceptor material may be nickel or a nickel alloy.

The susceptor 160 may be formed by electroplating at least one patch of the second susceptor material onto a strip of the first susceptor material. The susceptor may be formed by cladding a strip of the second susceptor material to a strip of the first susceptor material.

The aerosol-generating article 100 illustrated in FIG. 1 is designed to engage with an aerosol-generating device, such as the aerosol-generating device 200 illustrated in FIG. 2A, for producing an aerosol. The aerosol-generating device 200 comprises a housing 210 having a cavity 220 configured to receive the aerosol-generating article 100 and an inductive heating device 230 configured to heat an aerosol-generating article 100 for producing an aerosol. FIG. 2B illustrates the aerosol-generating device 200 when the aerosol-generating article 100 is inserted into the cavity 220.

The inductive heating device 230 is illustrated as a block diagram in FIG. 3. The inductive heating device 230 comprises a DC power source 310 and a heating arrangement 320 (also referred to as power supply electronics). The heating arrangement comprises a controller 330, a DC/AC converter 340, a matching network 350 and an inductor 240.

The DC power source 310 is configured to provide DC power to the heating arrangement 320. Specifically, the DC power source 310 is configured to provide a DC supply voltage (V_{DC}) and a DC current (I_{DC}) to the DC/AC converter 340. Preferably, the power source 310 is a battery, such as a lithium ion battery. As an alternative, the power source 310 may be another form of charge storage device such as a capacitor. The power source 310 may require recharging. For example, the power source 310 may have sufficient capacity to allow for the continuous generation of aerosol for a period of around six minutes or for a period that is a multiple of six minutes. In another example, the power source 310 may have sufficient capacity to allow for a predetermined number of puffs or discrete activations of the heating arrangement.

The DC/AC converter 340 is configured to supply the inductor 240 with a high frequency alternating current. As used herein, the term “high frequency alternating current” means an alternating current having a frequency of between about 500 kilohertz and about 30 megahertz. The high frequency alternating current may have a frequency of between about 1 megahertz and about 30 megahertz, such as between about 1 megahertz and about 10 megahertz, or such as between about 5 megahertz and about 8 megahertz.

FIG. 4 schematically illustrates the electrical components of the inductive heating device 230, in particular the DC/AC converter 340. The DC/AC converter 340 preferably comprises a Class-E power amplifier. The Class-E power amplifier comprises a transistor switch 410 comprising a Field Effect Transistor 420, for example a Metal-Oxide-Semiconductor Field Effect Transistor, a transistor switch supply circuit indicated by the arrow 430 for supplying a switching signal (gate-source voltage) to the Field Effect Transistor 420, and an LC load network 440 comprising a shunt capacitor C1 and a series connection of a capacitor C2 and inductor L2, corresponding to inductor 240. In addition, the DC power source 310, comprising a choke L1, is shown for supplying the DC supply voltage V_{DC}, with a DC current I_{DC} being drawn from the DC power source 310 during operation. The ohmic resistance R representing the total ohmic load 450, which is the sum of the ohmic resistance R_{coil} of the inductor L2 and the ohmic resistance R_{load} of the susceptor 160, is shown in more detail in FIG. 5.

Although the DC/AC converter 340 is illustrated as comprising a Class-E power amplifier, it is to be understood that the DC/AC converter 340 may use any suitable circuitry that converts DC current to AC current. For example, the DC/AC converter 340 may comprise a class-D power amplifier comprising two transistor switches. As another example, the DC/AC converter 340 may comprise a full bridge power inverter with four switching transistors acting in pairs.

Turning back to FIG. 3, the inductor 240 may receive the alternating current from the DC/AC converter 340 via a matching network 350 for optimum adaptation to the load, but the matching network 350 is not essential. The matching network 350 may comprise a small matching transformer. The matching network 350 may improve power transfer efficiency between the DC/AC converter 340 and the inductor 240.

As illustrated in FIG. 2A, the inductor 240 is located adjacent to the distal portion 225 of the cavity 220 of the aerosol-generating device 200. Accordingly, the high frequency alternating current supplied to the inductor 240 during operation of the aerosol-generating device 200 causes the inductor 240 to generate a high frequency alternating magnetic field within the distal portion 225 of the aerosol-generating device 200. The alternating magnetic field preferably has a frequency of between 1 and 30 megahertz, preferably between 2 and 10 megahertz, for example between 5 and 7 megahertz. As can be seen from FIG. 2B, when an aerosol-generating article 100 is inserted into the cavity 200, the aerosol-forming substrate 110 of the aerosol-generating article 100 is located adjacent to the inductor 240 so that the susceptor 160 of the aerosol-generating article 100 is located within this alternating magnetic field. When the alternating magnetic field penetrates the susceptor 160, the alternating magnetic field causes heating of the susceptor 160. For example, eddy currents are generated in the susceptor 160 which is heated as a result. Further heating is provided by magnetic hysteresis losses within the susceptor 160. The heated susceptor 160 heats the aerosol-forming substrate 110 of the aerosol-generating article 100 to a sufficient temperature to form an aerosol. The aerosol is drawn downstream through the aerosol-generating article 100 and inhaled by the user.

The controller 330 may be a microcontroller, preferably a programmable microcontroller. The controller 330 is programmed to regulate the supply of power from the DC power source 310 to the inductive heating arrangement 320 in order to control the temperature of the susceptor 160.

The power supply electronics 320 may comprise one or more temperature sensors (not shown) to measure a temperature of the power supply electronics 320. The controller 330 is configured to read the output of the one or more temperature sensors. At least one temperature sensor of the one or more temperature sensors may be located on the printed circuit board of the power supply electronics 320. The controller 330 may comprise at least one temperature sensor. Preferably, at least one temperature sensor is configured to measure at least the temperature of the printed circuit board of the power supply electronics 320. The at least one temperature sensor may be located so as to measure the temperature of the inductor L2. The at least one temperature sensor may comprise one or more of a thermocouple, a negative temperature coefficient resistive temperature sensor or a positive temperature coefficient resistive temperature sensor.

FIG. 6 illustrates the relationship between the DC current I_{DC} drawn from the power source 310 over time as the temperature of the susceptor 160 (indicated by the dashed line) increases. More specifically, FIG. 6 illustrates the remotely-detectable DC current changes that occur when a susceptor material undergoes a phase transition associated with its Curie point. The DC current I_{DC} drawn from the power source 310 is measured at an input side of the DC/AC converter 340. For the purpose of this illustration, it may be assumed that the voltage V_{DC} of the power source 310 remains approximately constant. It is to be noted that because the behaviour of DC current drawn from the power source I_{DC} over the temperature range of the phase transition is used to calibrate the aerosol-generating device 200, as described in detail below, the characteristic shape of the relationship between the DC current I_{DC} drawn from the power source 310 over time as the temperature of the susceptor 160 increases may be referred to as the calibration curve 600.

As the susceptor 160 is inductively heated, the apparent resistance of the susceptor 160 increases. This increase in resistance is observed as a decrease in the DC current I_{DC} drawn from the power source 310, which at constant voltage decreases as the temperature of the susceptor 160 increases. The high frequency alternating magnetic field provided by the inductor 240 induces eddy currents in close proximity to the susceptor surface, an effect that is known as the skin effect. The resistance in the susceptor 160 depends in part on the electrical resistivity of the first susceptor material, the resistivity of the second susceptor material and in part on the depth of the skin layer in each material available for induced eddy currents, and the resistivity is in turn temperature dependent.

As the second susceptor material reaches its Curie temperature, it loses its magnetic properties. This causes an increase in the skin layer available for eddy currents in the second susceptor material, which causes a decrease in the apparent resistance of the susceptor 160. The result is a temporary increase in the detected DC current I_{DC}. Then, when the skin depth of the second susceptor material begins to increase, the resistance begins to fall. This is seen as the valley (the local minimum) 610 in FIG. 6.

As heating continues, the current continues to increase until the maximum skin depth is reached, which coincides with the point where the second susceptor material has lost its spontaneous magnetic properties. This point is called the Curie temperature and is seen as the hill (the local maximum) 620 in FIG. 6. At this point the second susceptor material has undergone a phase change from a ferro-magnetic or ferri-magnetic state to a paramagnetic state. At this point, the susceptor 160 is at a known temperature (the Curie temperature, which is an intrinsic material-specific temperature).

If the inductor 240 continues to generate an alternating magnetic field (i.e. power to the DC/AC converter 340 is not interrupted) after the Curie temperature has been reached, the eddy currents generated in the susceptor 160 will run against the resistance of the susceptor 160, whereby Joule heating in the susceptor 160 will continue, and thereby the resistance will increase again (the resistance will have a polynomial dependence of the temperature, which for most metallic susceptor materials can be approximated to a third degree polynomial dependence for our purposes) and current will start falling again as long as the inductor 240 continues to provide power to the susceptor 160.

Therefore, the second susceptor material undergoes a reversible phase transition when heated through the (known) temperature range between the valley 610 and the hill 620 shown in FIG. 6. As can be seen from FIG. 6, the apparent resistance of the susceptor 160, and hence the start and end of the phase transition, can be remotely detected by monitoring the DC current I_{DC} drawn from the power source 310. Alternatively, the apparent resistance of the susceptor 160, and hence the start and end of the phase transition, can be remotely detected by monitoring a conductance value (where conductance is defined as the ratio of the DC current I_{DC} to the DC supply voltage V_{DC}) or a resistance value (where resistance is defined as the ratio of the DC supply voltage V_{DC} to the DC current I_{DC}). At least the DC current I_{DC} drawn from the power source 310 is monitored by the controller 330. Although the DC supply voltage V_{DC} is known, preferably both the DC current I_{DC} drawn from the power source 310 and the DC supply voltage V_{DC} are monitored. The DC current I_{DC}, the conductance value and the resistance value may be referred to as power source parameters.

As the susceptor 160 is heated, a first turning point 610 (corresponding to a local minimum for current and a local maximum for resistance) corresponds to the start of the phase transition. Then, as the susceptor continues to be heated, a second turning point 620 (corresponding to a local maximum for current and a local minimum for resistance) corresponds to the end of the phase transition.

Furthermore as can be seen from FIG. 6, the apparent resistance of the susceptor 160 (and correspondingly the current I_{DC} drawn from the power source 310) may vary with the temperature of the susceptor 160 in a strictly monotonic relationship over certain ranges of temperature of the susceptor 160, such as between the valley 610 and the hill 620. The strictly monotonic relationship allows for an unambiguous determination of the temperature of the susceptor 160 from a determination of the apparent resistance (R) or apparent conductance (1/R). This is because each determined value of the apparent resistance is representative of only one single value of the temperature, so that there is no ambiguity in the relationship. The monotonic relationship of the temperature of the susceptor 160 and the apparent resistance in the temperature range in which the second susceptor material undergoes the reversible phase transition allows for the determination and control of the temperature of the susceptor 160 and thus for the determination and control of the temperature of the aerosol-forming substrate 110.

The controller 330 regulates the supply of power provided to the heating arrangement 320 based on a power supply parameter. The heating arrangement 320 may comprise a current sensor (not shown) to measure the DC current I_{DC}. The heating arrangement 320 may optionally comprise a voltage sensor (not shown) to measure the DC supply voltage V_{DC}. The current sensor and the voltage sensor are located at an input side of the DC/AC converter 340. The DC current I_{DC} and optionally the DC supply voltage V_{DC} are provided by feedback channels to the controller 330 to control the further supply of AC power P_{AC} to the inductor 240.

The controller 330 may control the temperature of the susceptor 160 by maintaining the measured power supply parameter value at a target value corresponding to a target operating temperature of the susceptor 160. The controller 330 may use any suitable control loop to maintain the measured power supply parameter at the target value, for example by using a proportional-integral-derivative control loop.

In order to take advantage of the strictly monotonic relationship between the apparent resistance (or apparent conductance) of the susceptor 160 and the temperature of the susceptor 160, during user operation for producing an aerosol, the power supply parameter measured at the input side of the DC/AC converter 340 is maintained between a first calibration value corresponding to a first calibration temperature and a second calibration value corresponding to a second calibration temperature. The second calibration temperature is the Curie temperature of the second susceptor material (the hill 620 in the current plot in FIG. 6). The first calibration temperature is a temperature greater than or equal to the temperature of the susceptor at which the skin depth of the second susceptor material begins to increase, leading to a temporary lowering of the resistance (the valley 610 in the current plot in FIG. 6). Thus, the first calibration temperature is a temperature greater than or equal to the temperature at maximum permeability of the second susceptor material. The first calibration temperature is at least 50 degrees Celsius lower than the second calibration temperature. At least the second calibration value may be determined by calibration of the susceptor 160, as will be described in more detail below. The first calibration value and the second calibration value may be stored as calibration values in a memory of the controller 330.

Further, the controller 330 may maintain the temperature of the susceptor 160 below a predetermined threshold temperature by maintaining the measured conductance or current value below a predetermined threshold conductance value or by maintaining the measured resistance value above a predetermined threshold resistance value. The predetermined threshold temperature is chosen to prevent overheating of the aerosol-forming substrate. The predetermined threshold temperature may be the same as the second calibration temperature. If the measured power supply parameter indicates that the temperature of the susceptor is above the predetermined threshold temperature, the controller 330 is programmed to enter a safety mode. In the safety mode, the controller 330 is configured to perform one or more actions such as generating an alarm that (visually and additionally or alternatively audibly) provides an overheating warning to the user, switching off the aerosol-generating device and preventing further use if the aerosol-generating device for a predefined period of time.

Since the power supply parameter will have a polynomial dependence on the temperature, the power supply parameter will behave in a nonlinear manner as a function of temperature. However, the first and the second calibration values are chosen so that this dependence may be approximated as being linear between the first calibration value and the second calibration value because the difference between the first and the second calibration values is small, and the first and the second calibration values are in the upper part of the operational temperature range. Therefore, to adjust the temperature to a target operating temperature, the power supply parameter is regulated according to the first calibration value and the second calibration value, through linear equations.

For example, if the first and the second calibration values are conductance values, the target conductance value, G_{R}, corresponding to the target operating temperature may be given by:

G_{R}=G_{Lower}+(x×ΔG)

where ΔG is the difference between the first conductance value and the second conductance value and x is a percentage of ΔG.

The controller 330 may control the provision of power to the heating arrangement 320 by adjusting the duty cycle of the switching transistor 410 of the DC/AC converter 340. For example, during heating, the DC/AC converter 340 continuously generates alternating current that heats the susceptor 160, and simultaneously the DC current I_{DC} and optionally the DC supply voltage V_{DC} may be measured, preferably every millisecond for a period of 100 milliseconds.

For example, if the conductance or current is monitored by the controller 330 for adjusting the susceptor temperature, when the conductance or current reaches or exceeds a value corresponding to the target operating temperature for adjusting the susceptor temperature, the duty cycle of the switching transistor 410 is reduced. If the resistance is monitored by the controller 330 for adjusting the susceptor temperature, when the resistance reaches or goes below a value corresponding to the target operating temperature, the duty cycle of the switching transistor 410 is reduced. For example, the duty cycle of the switching transistor 410 may be reduced to about 10%. In other words, the switching transistor 410 may be switched to a mode in which it generates pulses only every 10 milliseconds for a duration of 1 millisecond. During this 1 millisecond on-state (conductive state) of the switching transistor 410, the values of the DC supply voltage V_{DC} and of the DC current I_{DC} are measured and the conductance is determined. As the conductance decreases (or the resistance increases) to indicate that the temperature of the susceptor 160 is below the target operating temperature, the gate of the transistor 410 is again supplied with the train of pulses at the chosen drive frequency for the system.

The power may be supplied by the controller 330 to the inductor 240 in the form of a series of successive pulses of electrical current. In particular, power may be supplied to the inductor 240 in a series of pulses, each separated by a time interval. The series of successive pulses may comprise two or more heating pulses and one or more probing pulses between successive heating pulses. The heating pulses have an intensity such as to heat the susceptor 160. The probing pulses are isolated power pulses having an intensity such not to heat the susceptor 160 but rather to obtain a feedback on the power supply parameter and then on the evolution (decreasing) of the susceptor temperature. The controller 330 may control the power by controlling the duration of the time interval between successive heating pulses of power supplied by the DC power supply to the inductor 240. Additionally or alternatively, the controller 330 may control the power by controlling the length (in other words, the duration) of each of the successive heating pulses of power supplied by the DC power supply to the inductor 240.

The controller 330 is programmed to perform a calibration process in order to obtain the calibration values at which the power supply parameter is measured at known temperatures of the susceptor 160. The known temperatures of the susceptor may be the first calibration temperature corresponding to the first calibration value and the second calibration temperature corresponding to the second calibration value. The calibration process is performed each time the user operates the aerosol-generating device 200. For example, the controller 330 may be configured to enter a calibration mode for performing the calibration process when the user switches on the aerosol-generating device. The controller 330 may be programmed to enter the calibration mode each time the user inserts an aerosol-generating article 100 into an aerosol-generating device 200. Thus, the calibration process is performed during a first heating phase of the aerosol-generating device, before user operation of the aerosol-generating device 200 for generating an aerosol.

During the calibration process, the controller 330 controls the DC/AC converter 340 to continuously or continually supply power to the inductor 240 in order to heat the susceptor 160. The controller 330 monitors the power supply parameter by measuring the current I_{DC} drawn by the power supply and, optionally the power supply voltage V_{DC}. As discussed above in relation to FIG. 6, as the susceptor 160 is heated, the measured current decreases until a first turning point 610 is reached and the current begins to increase. This first turning point 610 corresponds to a local minimum conductance or current value (a local maximum resistance value). The controller 330 may record the power supply parameter at the first turning point 610 as the first calibration value.

The conductance or resistance values may be determined based on the measured current I_{DC} and the measured voltage V_{DC}. Alternatively, it may be assumed that the power supply voltage V_{DC}, which is a known property of the power source 310, is approximately constant. The temperature of the susceptor 160 at the first calibration value is referred to as the first calibration temperature. Preferably, the first calibration temperature is between 150 degrees Celsius and 350 degrees Celsius. More preferably, when the aerosol-forming substrate 110 comprises tobacco, the first calibration temperature is 320 degrees Celsius. The first calibration temperature is at least 50 degrees Celsius lower than the second calibration temperature.

As the controller 330 continues to control the power provided by the DC/AC converter 340 to the inductor 240, the controller 330 continues to monitor the power supply parameter until a second turning point 620 is reached. The second turning point corresponds to a maximum current (corresponding to the Curie temperature of the second susceptor material) before the measured current begins to decrease. This second turning point 620 corresponds to a local maximum conductance or current value (a local minimum resistance value). The controller 330 records the power supply parameter value at the second turning point 620 as the second calibration value. The temperature of the susceptor 160 at the second calibration value is referred to as the second calibration temperature. Preferably, the second calibration temperature is between 200 degrees Celsius and 400 degrees Celsius. When the second turning point 620 is detected, the controller 330 controls the DC/AC converter 340 to interrupt provision of power to the inductor 240, resulting in a decrease in susceptor 160 temperature and a corresponding decrease in measured current.

Due to the shape of the graph 600, this process of continuously heating the susceptor 160 to obtain the first calibration value and the second calibration value may be repeated at least once during the calibration mode. After interrupting provision of power to the inductor 240, the controller 330 continues to monitor the power supply parameter until a third turning point is observed. The third turning point corresponds to a second minimum conductance or current value (a second maximum resistance value). When the third turning point is detected, the controller 330 controls the DC/AC converter 340 to continuously provide power to the inductor 240 until a fourth turning point in the monitored power supply parameter is observed. The fourth turning point corresponds to a second maximum conductance or current value (a second minimum resistance value). The controller 330 stores the power supply parameter value that is measured at the third turning point as the first calibration value and the power supply parameter value measured the fourth turning point as the second calibration value. The repetition of the measurement of the turning points corresponding to minimum and maximum measured current significantly improves the subsequent temperature regulation during user operation of the device for producing an aerosol. Preferably, controller 330 regulates the power based on the power supply parameter values obtained from the second maximum and the second minimum, this being more reliable because the heat will have had more time to distribute within the aerosol-forming substrate 110 and the susceptor 160.

The controller 330 is configured to detect the turning points 610 and 620 by measuring a sequence of power source parameter values. With reference to FIG. 6, the sequence of measured power source parameter values will form a curve, with each value being greater than or less than the previous value. The controller 330 is configured to measure the calibration value at the point where the curve begins to flatten. In other words, the controller 330 records the calibration values when the difference between consecutive power supply parameter values is below a predetermined threshold value.

Further, during the first heating phase, in order to further improve the reliability of the calibration process, the controller 310 may be optionally programmed to perform a pre-heating process before the calibration process. For example, if the aerosol-forming substrate 110 is particularly dry or in similar conditions, the calibration may be performed before heat has spread within the aerosol-forming substrate 110, reducing the reliability of the calibration values. If the aerosol-forming substrate 110 were humid, the susceptor 160 takes more time to reach the valley temperature (due to water content in the substrate 110).

To perform the pre-heating process, the controller 330 is configured to continuously provide power to the inductor 240. As described above with respect to FIG. 6, the measured current starts decreasing with increasing susceptor 160 temperature until a turning point 610 corresponding to minimum measured current is reached. At this stage, the controller 330 is configured to wait for a predetermined period of time to allow the susceptor 160 to cool before continuing heating. The controller 330 therefore controls the DC/AC converter 340 to interrupt provision of power to the inductor 240. After the predetermined period of time, the controller 330 controls the DC/AC converter 340 to provide power until the turning point 610 corresponding to the minimum measured current is reached again. At this point, the controller controls the DC/AC converter 340 to interrupt provision of power to the inductor 240 again. The controller 330 again waits for the same predetermined period of time to allow the susceptor 160 to cool before continuing heating. This heating and cooling of the susceptor 160 is repeated for the predetermined duration of time of the pre-heating process. The predetermined duration of the pre-heating process is preferably 11 seconds. The predetermined combined durations of the pre-heating process followed by the calibration process is preferably 20 seconds.

If the aerosol-forming substrate 110 is dry, the first current minimum of the pre-heating process is reached within the pre-determined period of time and the interruption of power will be repeated until the end of the predetermined time period. If the aerosol-forming substrate 110 is humid, the first current minimum of the pre-heating process will be reached towards the end of the pre-determined time period. Therefore, performing the pre-heating process for a predetermined duration ensures that, whatever the physical condition of the substrate 110, the time is sufficient for the substrate 110 to reach the minimum operating temperature, in order to be ready to feed continuous power and reach the first maximum. This allows a calibration as early as possible, but still without risking that the substrate 110 would not have reached the valley 610 beforehand.

Further, the aerosol-generating article 100 may be configured such that the current minimum 610 is always reached within the predetermined duration of the pre-heating process. If the current minimum 610 is not reached within the pre-determined duration of the pre-heating process, this may indicate that the aerosol-generating article 100 comprising the aerosol-forming substrate 110 is not suitable for use with the aerosol-generating device 200. For example, the aerosol-generating article 100 may comprise a different or lower-quality aerosol-forming substrate 110 than the aerosol-forming substrate 100 intended for use with the aerosol-generating device 200. As another example, the aerosol-generating article 100 may not be configured for use with the heating arrangement 320, for example if the aerosol-generating article 100 and the aerosol-generating device 200 are manufactured by different manufacturers. Thus, the controller 330 may be configured to generate a control signal to cease operation of the aerosol-generating device 200.

As mentioned above, as the first stage of the calibration process, the pre-heating process may be performed in response to receiving a user input, for example user activation of the aerosol-generating device 200. Additionally or alternatively, the controller 330 may be configured to detect the presence of an aerosol-generating article 100 in the aerosol-generating device 200 and the pre-heating process may be performed in response to detecting the presence of the aerosol-generating article 100 within the cavity 220 of the aerosol-generating device 200.

FIG. 7 is a graph of conductance against time showing a heating profile of the susceptor 160. The graph illustrates two consecutive phases of heating: a first heating phase 710 comprising the pre-heating process 710A and the calibration process 710B described above, and a second heating phase 720 corresponding to user operation of the aerosol-generating device 200 to produce an aerosol. It is to be understood that FIG. 7 is not shown to scale. Specifically, the first heating phase 710 has a shorter duration that the second heating phase 720. For example, the first heating phase 710 may have a duration of between 5 seconds and 30 seconds, preferably between 10 and 20 seconds. The second heating phase 720 may have a duration of between 140 and 340 seconds.

Further, although FIG. 7 is illustrated as a graph of conductance against time, it is to be understood that the controller 330 may be configured to control the heating of the susceptor 160 during the first heating phase 710 and the second heating phase 720 based on measured resistance or current as described above. Indeed, although the techniques to control of the heating of the susceptor during the first heating phase 710 and the second heating phase 720 have been described above based on a determined conductance value or a determined resistance value associated with the susceptor, it is to be understood that the techniques described above could be performed based on a value of current measured at the input of the DC/AC converter 340.

As can be seen from FIG. 7, the second heating phase 720 comprises a plurality of conductance steps, corresponding to a plurality of temperature steps from a first operating temperature of the susceptor 160 to a second operating temperature of the susceptor 160. The first operating temperature of the susceptor is a temperature at which the aerosol-forming substrate 110 forms an aerosol so that an aerosol is formed during each temperature step. Preferably, the first operating temperature of the susceptor is a minimum temperature at which the aerosol-forming substrate will form an aerosol in a sufficient volume and quantity for a satisfactory experience when inhaled a user. The second operating temperature of the susceptor is the temperature at maximum temperature at which it is desirable for the aerosol-forming substrate to be heated for the user to inhale the aerosol.

The first operating temperature of the susceptor 160 is greater than or equal to the first calibration temperature of the susceptor 160, corresponding to the first calibration value (the valley 610 of the current plot shown in FIG. 6). The first operating temperature may be between 150 degrees Celsius and 330 degrees Celsius. The second operating temperature of the susceptor 160 is less than or equal to the second calibration temperature of the susceptor 160, corresponding to the second calibration value at the Curie temperature of the second susceptor material (the hill 620 of the current plot shown in FIG. 6). The second operating temperature may be between 200 degrees Celsius and 400 degrees Celsius. The difference between the first operating temperature and the second operating temperature is at least 50 degree Celsius.

It is to be understood that the number of temperature steps illustrated in FIG. 7 is exemplary and that second heating phase 720 comprises at least three consecutive temperature steps, preferably between two and fourteen temperature steps, most preferably between three and eight temperature steps. Each temperature step may have a predetermined duration. Preferably the duration of the first temperature step is longer than the duration of subsequent temperature steps. The duration of each temperature step is preferably longer than 10 seconds, preferably between 30 seconds and 200 seconds, more preferably between 40 seconds and 160 seconds. The duration of each temperature step may correspond to a predetermined number of user puffs. Preferably, the first temperature step corresponds to four user puffs and each subsequent temperature step corresponds to one user puff.

For the duration of each temperature step, the temperature of the susceptor 160 is maintained at a target operating temperature corresponding to the respective temperature step. Thus, for the duration of each temperature step, the controller 330 controls the provision of power to the heating arrangement 320 such that the measured power source parameter is maintained at a target value corresponding to the target operating temperature of the respective temperature step, where the target value is determined with reference to the first calibration value and the second calibration value as described above.

As an example, the second heating phase 720 may comprise five temperature steps: a first temperature step 720a having a duration of 160 seconds and a target conductance value of G_{R}=G_{Lower}+(0.09×ΔG), a second temperature step 720b having a duration of 40 seconds and a target conductance value of G_{R}=G_{Lower}+(0.25×ΔG), a third temperature step 720c having a duration of 40 seconds and a target conductance value of G_{R}=G_{Lower}+(0.4×ΔG), a fourth temperature step 720d having a duration of 40 seconds and a target conductance value of G_{R}=G_{Lower}+(0.56×ΔG) and a fifth temperature step 720e having a duration of 85 seconds and a target conductance value of G_{R}=G_{Lower}+(0.75×ΔG). These temperature steps may correspond to temperatures of 330 degrees Celsius, 340 degrees Celsius, 345 degrees Celsius, 355 degrees Celsius and 380 degrees Celsius.

However, the first calibration value and the second calibration value used to determine the target power source parameter value for each temperature step will drift over the duration of the second heating phase 720 due to the fact that the temperature of the power supply electronics 320 increases during operation of the aerosol-generating device 200. Specifically, as shown in FIG. 5, the apparent resistance of the susceptor 160 is the sum of the ohmic resistance R_{coil} of the inductor L2 and the ohmic resistance R_{load} of the susceptor 160, meaning that any change to the temperature of the inductor L2 during operation of the device 200 will affect the apparent resistance. This is illustrated in FIG. 8, which is a graph of conductance over time showing the downward drift of the calibration curve over time as the power supply electronics are heated.

FIG. 8 illustrates a first calibration curve 800A obtained during calibration during the first heating phase 710 as a solid line. The (increasing) temperature of the power supply electronics 320 is illustrated as a dashed line. The calibration curves 800B-F having a dashed line represent exemplary calibration curves that would be obtained if calibration were to be performed at a later time while the temperature of the power supply electronics 320 increases. As can be seen from FIG. 8, the value of conductance at the turning points of the calibration curves drift downwards. In particular, the value of conductance at the hill 620 drifts downwards as the temperature of the power supply electronics 320 increases, indicated by the dotted line. Further, as can be seen from FIG. 8, the temperature of the power supply electronics 320 increases more rapidly at the beginning due to there being a larger temperature gradient before levelling off. Accordingly, the downward drift of the calibration curves 800A-F is more rapid at the beginning when the temperature is changing more rapidly.

FIG. 9 illustrates the downward drift in conductance in more detail. Calibration curve S₁ represents the calibration curve measured during the calibration process during the first heating phase 710. As described above, the heating of the susceptor 160 is then regulated at a value of target conductance G_{R} defined by a predetermined percentage of ΔG₁. In this example, the heating of the susceptor 160 is initially regulated at 50% of ΔG₁ such that G_{R1}=G_{lower}+(0.5×ΔG₁).

Calibration curve S₂ represents a calibration measured at a later time, when the temperature of the power supply electronics 320 is higher than during the calibration process to obtain curve S₁. As can be seen from FIG. 9, the difference between the conductance values at the first and second turning points remains unchanged (ΔG₁=ΔG₂), but the values of conductance at the first turning point 610 and the second turning point 620 have decreased by a value ΔD. However, the temperatures of the susceptor 160 at the turning points 610 and 620 remain the same as this is a property of the susceptor materials. Thus, for a given susceptor temperature, the target conductance or current value will drift downwards during operation of the aerosol-generating device 200. (In terms of resistance, for a given susceptor temperature, the target resistance value will drift upwards during operation of the aerosol-generating device 200).

Accordingly, if the measured conductance were to be maintained at the target value of G_{R1} throughout the second heating phase, the temperature of the susceptor 160 would increase over time. In particular, as can be seen from FIG. 9, G_{R1} is not at 50% of ΔG₂, but is closer to the hill of calibration curve S₂. It must be ensured that the temperature regulation always occurs between the first and the second calibration values in order to avoid overheating of the aerosol-generating substrate 110. Thus, at the time at which the second calibration curve S₂ is measured, the target conductance G_{R2} must be G_{R2}−ΔG_{R} to maintain the same susceptor temperature. In other words, G_{R2}=G_{lower}+(0.5×ΔG₁)−ΔG_{R2}.

During the second heating phase 720, the temperature of the power supply electronics 320 will be continuously monitored using the temperature sensor of the controller 330 and the power provided to the power supply electronics 320 will be adjusted based on a change of the measured temperature. Specifically, the target conductance or current value for each temperature step will decrease over the duration of the respective temperature step based on the measured temperature. The target resistance value for each temperature step will increase over the duration of the respective temperature step depending on the measured temperature. This is illustrated in FIG. 10, which shows the heating profile of FIG. 7 adjusted to compensate for the drift of the calibration values. It is to be understood that FIG. 10 is for illustrative purposes and not drawn to scale.

The amount of decrease of the current or conductance (the amount of increase of the resistance) is proportional to the change of the measured temperature of the power supply electronics 320. This ensures that the target power source parameter value remains between the hill 620 and the valley 610 of the calibration curve, thereby preventing overheating. The slope of each temperature step will progressively decrease until reaching a substantially flat shape towards the end. More specifically, the amount by which conductance is reduced is defined as:

ΔG_{R}=KΔT

where k is a drift compensation value and ΔT is a change of the measured temperature of the power supply electronics. The drift compensation value may be a constant. The drift compensation value may increase as the change of the measured temperature of the power supply electronics increases. Accordingly, ΔG_{R} may be determined based on a drift compensation value of a plurality of drift compensation values. This provides for more precise temperature regulation and in particular further ensures that overheating is prevented because the value of ΔG_{R} is further increased with larger increases in temperature.

One or more drift compensation values may be determined by performing the calibration process at least twice while heating the susceptor 160. The determination of the drift compensation values may be performed during manufacturing of the aerosol-generating device 200. Additionally or alternatively, the determination of the drift compensation values may be performed prior to the first heating stage 710, for example during configuration of the aerosol-generating device 200 when the user switches on the aerosol-generating device 200 for the first time. The calibration values obtained from each repetition of the calibration process are then used to determine one or more drift compensation values. The one or more drift compensation values may be stored in a memory of the aerosol-generating device 200, such as a memory of the controller 330. Thus, for each of a plurality of predefined changes in temperature of the power supply electronics 320, a drift compensation value may be stored.

In addition, during the second heating phase 720, the controller 330 may be configured to enter a recalibration mode to recalibrate the aerosol-generating device 200 by repeating at least part of the calibration process described above. By recalibrating the aerosol-generating device 200, the controller 330 re-measures at least one of the calibration values. The target power source parameter value for each temperature step will be determined using the last-measured at least one calibration value. The re-calibration may be performed periodically during the second heating phase 720, for example at one or more of predetermined time intervals or after a predetermined number of puffs. The first target power source parameter value after re-calibration will therefore initially be determined based on the re-measured calibration values. The drift compensation described above will be applied in response to detection of a temperature change of the power supply electronics 330 following the re-calibration. Accordingly, adjusting the target power source parameter values based on the temperature change of the power supply electronics provides the advantage of reducing the frequency of recalibrations needed during the second heating phase 720.

FIG. 11 is a flow diagram of a method 1100 for controlling aerosol-production in an aerosol-generating device 200. As described above, the controller 330 may be programmed to perform the method 1100.

The method begins at step 1110, where the controller 330 detects user operation of the aerosol-generating device 200 for producing an aerosol. Detecting user operation of the aerosol-generating device 200 may comprise detecting a user input, for example user activation of the aerosol-generating device 200. Additionally or alternatively, detecting user operation of the aerosol-generating device 200 may comprise detecting that an aerosol-generating article 100 has been inserted into the aerosol-generating device 200.

In response to detecting the user operation at step 1110, the controller 330 enters a calibration mode. During the calibration mode, the controller 330 may be configured to perform the optional pre-heating process described above (step 1120). At the end of the predetermined duration of the pre-heating process, the controller 330 is configured to perform the calibration process (step 1130) as described above. Alternatively, during the calibration mode, the controller 330 may be configured to proceed to step 1130 without performing the pre-heating process. Following completion of the calibration process, the controller 330 enters the heating mode of the second heating phase in which the aerosol is produced at step 1140.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A method for controlling aerosol production in an aerosol-generating device, the aerosol-generating device comprising an inductive heating arrangement configured to heat a susceptor, power supply electronics, and a power source configured to provide power to the power supply electronics, the method comprising:
controlling the power provided to the power supply electronics to cause the susceptor to have a target temperature;
measuring, using at least one temperature sensor, a temperature of the power supply electronics during operation of the aerosol-generating device for generating an aerosol; and
adjusting the power provided to the power supply electronics based on a change of the measured temperature of the power supply electronics.

17. The method according to claim 16, wherein the controlling the power provided to the power supply electronics comprises controlling the power provided to the power supply electronics to maintain a conductance value or a current value associated with the susceptor at a target value that corresponds to the target temperature.

18. The method according to claim 17, wherein the adjusting the power provided to the power supply electronics comprises controlling the power provided to the power supply electronics to decrease the conductance value or the current value associated with the susceptor as the measured temperature increases.

19. The method according to claim 18, wherein decreasing the conductance value or the current value associated with the susceptor as the measured temperature increases comprises decreasing a target conductance or current value by an amount based on a value of a change of the measured temperature such that the amount by which the target conductance or current value is decreased increases as the value of the change of the measured temperature increases.

20. The method according to claim 17,
wherein a target conductance value or target current value is determined based on a first calibration value corresponding to a first known temperature of the susceptor and a second calibration value corresponding to a second known temperature of the susceptor, and
wherein the second known temperature of the susceptor is greater than the first known temperature of the susceptor.

21. The method according to claim 20, wherein the target conductance value or target current value is defined according to a heating profile as a predetermined percentage of a difference between the first calibration value and the second calibration value.

22. The method according to claim 21, wherein the heating profile defines a stepwise increase of temperature from a first operating temperature to a second operating temperature.

23. An aerosol-generating device, comprising:
an inductive heating arrangement configured to heat a susceptor, the inductive heating arrangement comprising power supply electronics and a power source configured to provide power to the power supply electronics; and
a controller comprising at least one temperature sensor arranged to measure a temperature of the power supply electronics during operation of the aerosol-generating device for generating an aerosol, wherein the controller is configured to:
control the power provided to the power supply electronics to cause the susceptor to have a target temperature, and
adjust the power provided to the power supply electronics based on a change of the measured temperature of the power supply electronics.

24. The aerosol-generating device according to claim 23, wherein control of the power provided to the power supply electronics comprises control of the power provided to the power supply electronics to maintain a resistance value associated with the susceptor at a target value that corresponds to the target temperature.

25. The aerosol-generating device according to claim 24, wherein adjusting of the power provided to the power supply electronics comprises control of the power provided to the power supply electronics to increase the resistance value associated with the susceptor as the measured temperature increases.

26. The aerosol-generating device according to claim 25, wherein increasing the resistance value associated with the susceptor as the measured temperature increases comprises increasing the target resistance value by an amount based on a value of the change of the measured temperature such that the amount by which the target resistance value is increased increases as the value of the change of the measured temperature increases.

27. The aerosol-generating device according to claim 26, wherein the amount by which the target resistance value is decreased is based on the amount of change of the measured temperature multiplied by a drift compensation value.

28. The aerosol-generating device according to claim 27,
wherein the drift compensation value is a constant, or
wherein the drift compensation value increases as the measured temperature associated with the power supply electronics increases.

29. The aerosol-generating device according to claim 27, wherein the controller is further configured to determine the drift compensation value by performing steps comprising:
i) controlling the power provided to the power supply electronics to cause the susceptor to have a first known temperature,
when the susceptor is at the first known temperature:
ii) determining a conductance value, a current value, or a resistance value associated with the susceptor, and
iii) determining a temperature of associated with the power supply electronics, and
repeating steps i) to iii) at least twice.

30. An aerosol-generating system, comprising:
the aerosol-generating device according to claim 23; and
an aerosol-generating article comprising an aerosol-forming substrate and the susceptor in thermal contact with the aerosol-forming substrate.
